(19) United States
(12) Patent Application Publication
(10) Pub. No.: US 2022/0055123 A1
(43) Pub. Date: Feb. 24, 2022

(54) CUTTING INSERT, ROTARY TOOL, AND METHOD FOR MANUFACTURING MACHINED PRODUCT

(71) Applicant: KYOCERA Corporation, Kyoto-shi, Kyoto (JP)

(72) Inventor: Suguru ONCHI, Omihachiman-shi (JP)

(73) Assignee: KYOCERA Corporation, Kyoto-shi, Kyoto (JP)

(21) Appl. No.: 17/274,826

(22) PCT Filed: Sep. 10, 2019
(86) PCT No.: PCT/JP2019/035502

§ 371 Date: Mar. 10, 2021

(30) Foreign Application Priority Data
Sep. 12, 2018 (JP) 2018-170315

(51) Int. Cl. B23B 51/02

(52) U.S. Cl. CPC B23B 51/02; B23B 2251/082; B23B 2251/18; B23B 2251/40; B23B 2251/14; B23B 2251/127

(57) ABSTRACT

A cutting insert may include a base, a cutting edge and a flute. The base may include a rotation axis and may be extended from a first end to a second end. The cutting edge may be located on a side of the first end. The flute may be extended from the cutting edge toward the second end. The cutting edge may include a first cutting edge and a second cutting edge. The first cutting edge may intersect with the rotation axis in a front view. The second cutting edge may be located closer to an outer periphery than the first cutting edge, and a rake angle of the second cutting edge may have a positive value. The first cutting edge may be formed by round honing, and the second cutting edge may be formed by chamfer honing.

### CROSS-REFERENCE TO RELATED APPLICATION

This application is a national stage entry according to 35 U.S.C. 371 of PCT Application No. PCT/JP2019/035502, filed on Sep. 10, 2019, which claims priority to Japanese Application No. 2018-170315, filed on Sep. 12, 2018, which are entirely incorporated herein by reference.

### TECHNICAL FIELD

The present disclosure relates to a rotary tool for use in a cutting process. Examples of the rotary tool include drills and end mills.

### BACKGROUND

For example, a drill is discussed in Japanese Unexamined Patent Publication No. 2016-002617 (Patent Document 1) and may be used as a rotary tool for use in a cutting process of a workpiece, such as metal. The drill discussed in Patent Document 1 may include a cutting edge including a thinning cutting edge and a concave circular arc cutting edge part. A honed surface for edge reinforcement may be applied to an entire region of the cutting edge in Patent Document 1.

The honed surface may have a minimum width at a midpoint of the concave circular arc cutting edge part in Patent Document 1. Therefore, cracking may occur at the midpoint. However, if the width of the honed surface is increased for the edge reinforcement, biting properties may degrade.

### SUMMARY

A cutting insert in one embodiment may include a base, a cutting edge and a flute. The base may include a rotation axis and may be extended from a first end to a second end. The cutting edge may be located on a side of the first end of the base. The flute may be extended from the cutting edge toward the second end. The cutting edge may include a first cutting edge and a second cutting edge. The first cutting edge may intersect with the rotation axis in a front view. The second cutting edge may be located closer to an outer periphery than the first cutting edge. A rake angle of the second cutting edge may have a positive value. The first cutting edge may be formed by round honing, and the second cutting edge may be formed by chamfer honing.

### BRIEF DESCRIPTION OF THE DRAWINGS

FIG. 1 is a perspective view illustrating a rotary tool in one non-limiting aspect of the present disclosure;

FIG. 2 is an enlarged view of a region A1 illustrated in FIG. 1;

FIG. 3 is a front view of the rotary tool illustrated in FIG. 1;

FIG. 4 is a side view of the rotary tool illustrated in FIG. 3 if viewed from a B1 direction;

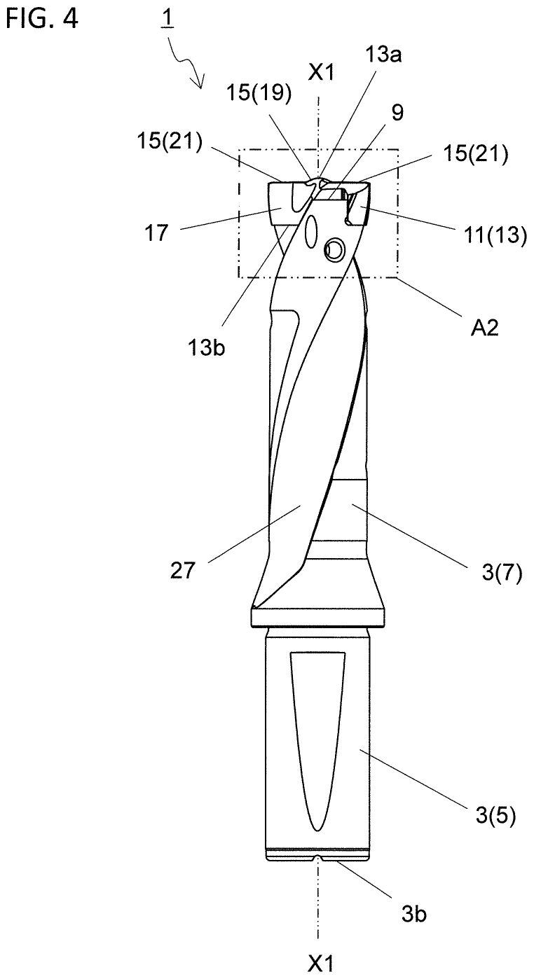

FIG. 5 is an enlarged view of a region A2 illustrated in FIG. 4;

FIG. 6 is a side view of the rotary tool illustrated in FIG. 3 if viewed from a B2 direction;

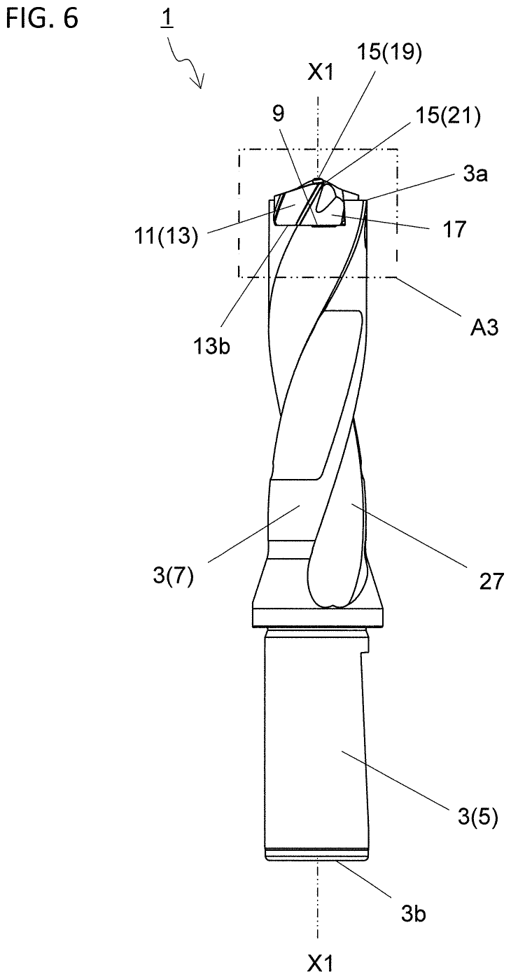

FIG. 7 is an enlarged view of a region A3 illustrated in FIG. 6;

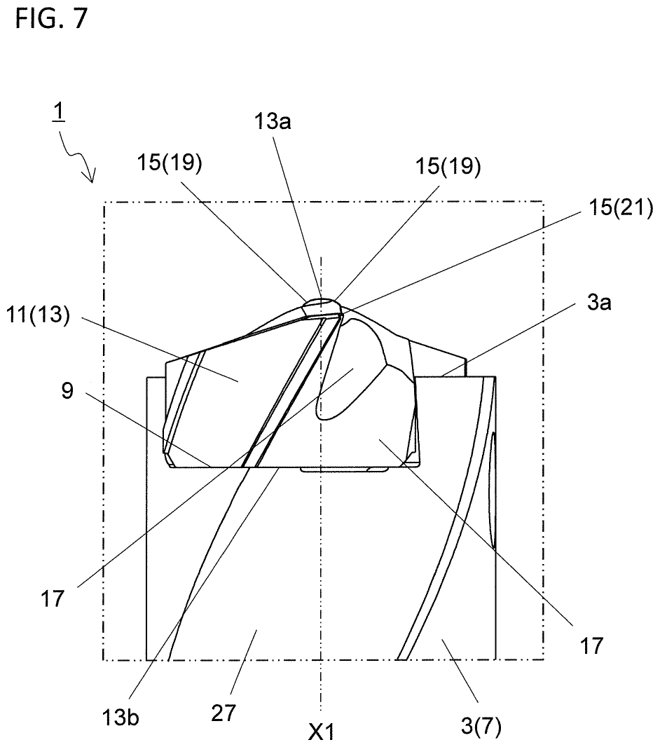

FIG. 8 is a sectional view taken along line VIII-VIII in the rotary tool illustrated in FIG. 3;

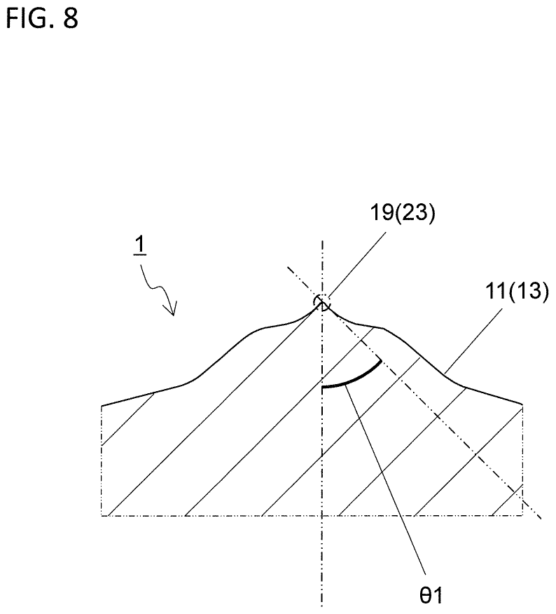

FIG. 9 is a sectional view taken along line IX-IX in the rotary tool illustrated in FIG. 3;

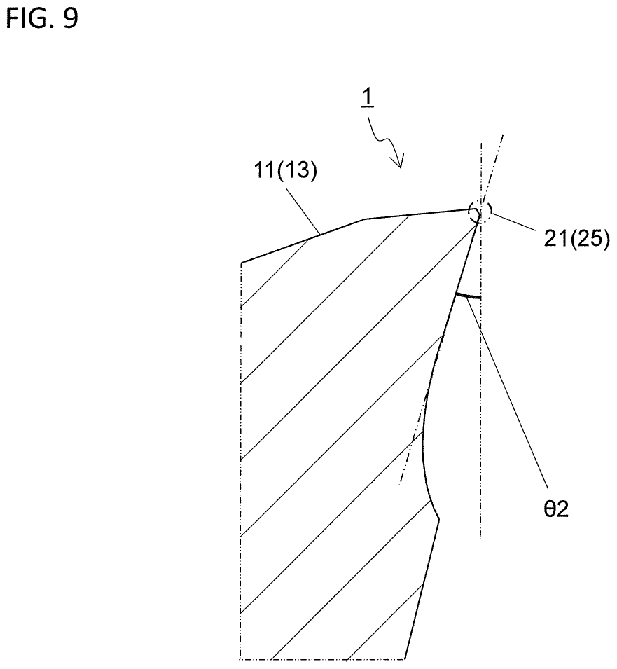

FIG. 10 is a sectional view taken along line X-X in the rotary tool illustrated in FIG. 3;

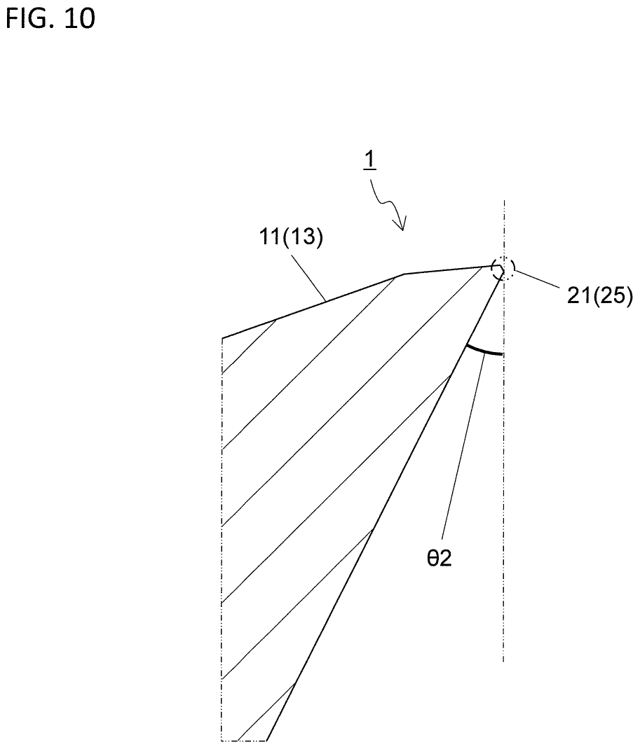

FIG. 11 is a perspective view illustrating a rotary tool in another non-limiting aspect of the present disclosure;

FIG. 12 is an enlarged view of a region A4 illustrated in FIG. 11;

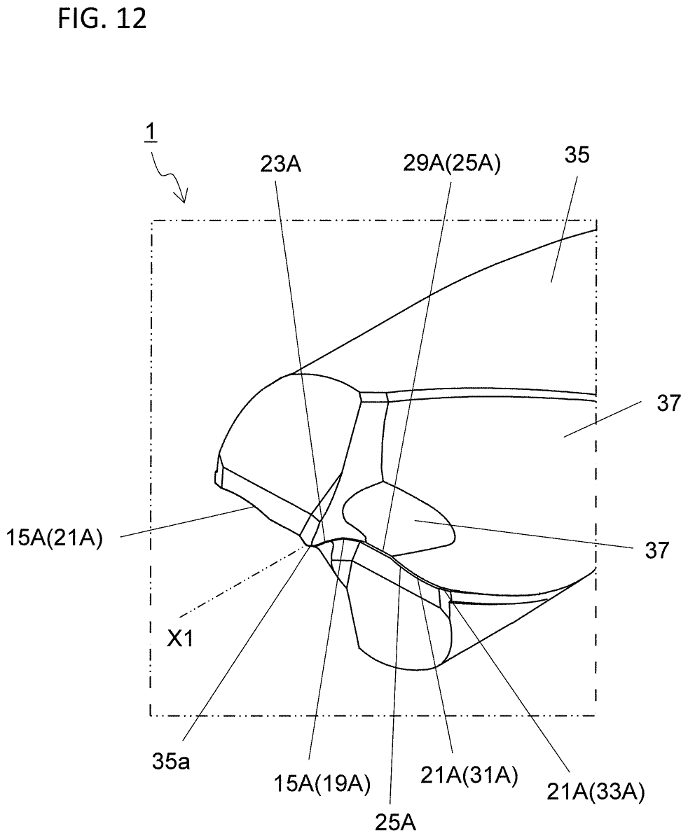

FIG. 13 is a front view of the rotary tool illustrated in FIG. 11;

FIG. 14 is a side view of the rotary tool illustrated in FIG. 13 if viewed from a B3 direction;

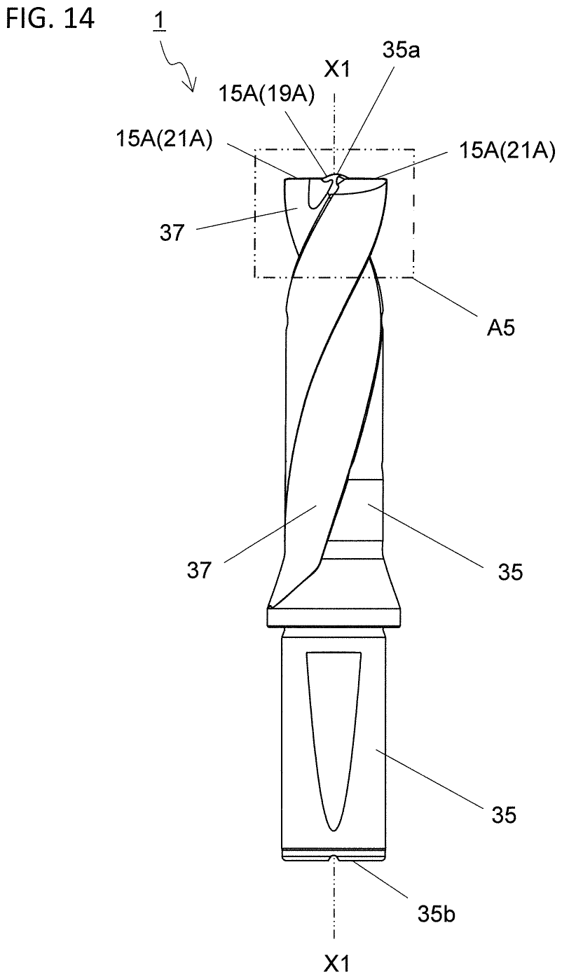

FIG. 15 is an enlarged view of a region A5 illustrated in FIG. 14;

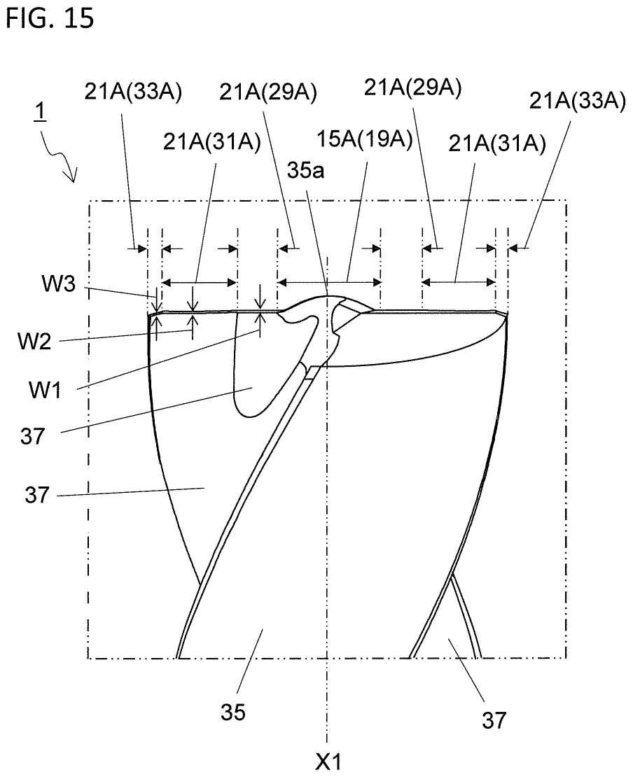

FIG. 16 is a schematic diagram illustrating one of steps in a method for manufacturing a machined product in one non-limiting aspect of the present disclosure;

FIG. 17 is a schematic diagram illustrating one of the steps in the method for manufacturing a machined product in the non-limiting aspect of the present disclosure; and

FIG. 18 is a schematic diagram illustrating one of the steps in the method for manufacturing a machined product in the non-limiting aspect of the present disclosure.

### EMBODIMENTS

Rotary tools 1 in embodiments may be described in detail below with reference to the drawings. For the sake of description, the drawings referred to in the following may illustrate, in simplified form, only main members necessary for describing the embodiments. The rotary tools 1 may therefore be capable of including any arbitrary structural member not illustrated in the drawings referred to in the present specification. Dimensions of the members in each of the drawings faithfully may represent neither dimensions of actual structural members nor dimensional ratios of these members.

<Rotary Tools>

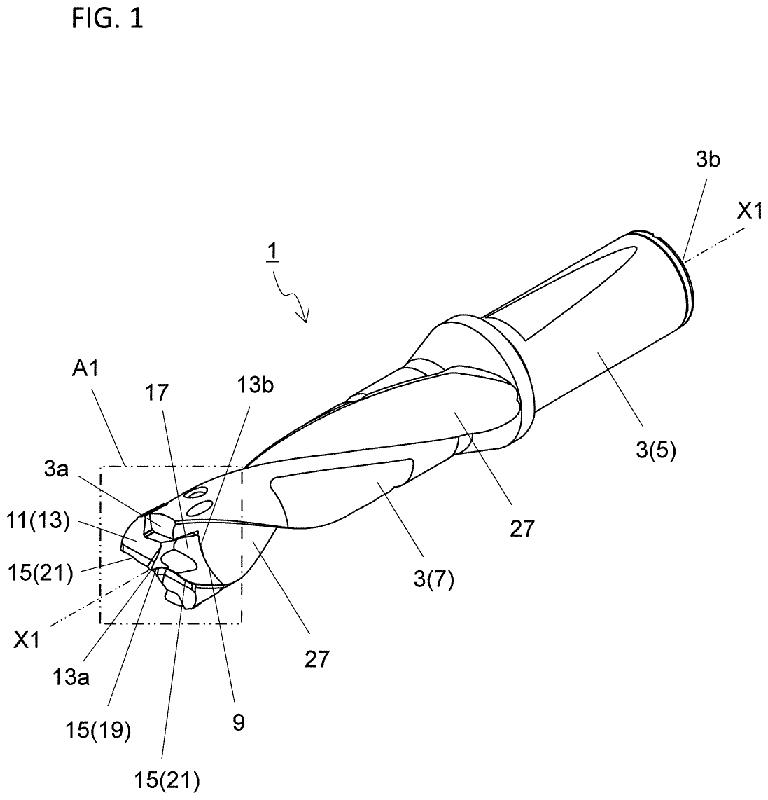

Examples of the rotary tools 1 may include drills. The rotary tool illustrated in FIG. 1 may be a drill. Examples of the rotary tools 1 may include, besides the drills, end mills.

The rotary tool 1 of one non-limiting aspect in the present disclosure may include a holder 3 which has a bar shape rotatable around a rotation axis X1 as illustrated in, for example, FIG. 1. The holder 3 may be extended from a front end 3a to a rear end 3b along the rotation axis X1. A lower left end may be the front end 3a, and an upper right end may be the rear end 3b in one embodiment illustrated in FIG. 1. The rotary tool 1 may be rotated around the rotation axis X1 in a cutting process of a workpiece. An arrow X2 in FIG. 1 and the like may indicate a rotation direction of the rotary tool 1.

The holder 3 may have the bar shape extended long and narrow along the rotation axis X1 as illustrated in, for example, FIG. 1. The holder 3 may include a part called a shank 5, and a part called a body 7. The shank 5 may be the part that can be held by, for example, a spindle rotatable in a machine tool. The body 7 may be located closer to the front end 3a than the shank 5.

An outer diameter D of the body 7 (holder 3) is not limited to a specific value. For example, the outer diameter D may be set to 6-42.5 mm. A length L of the holder 3 in a direction along the rotation axis X1 may be set to L=1.5 D to L=12 D.

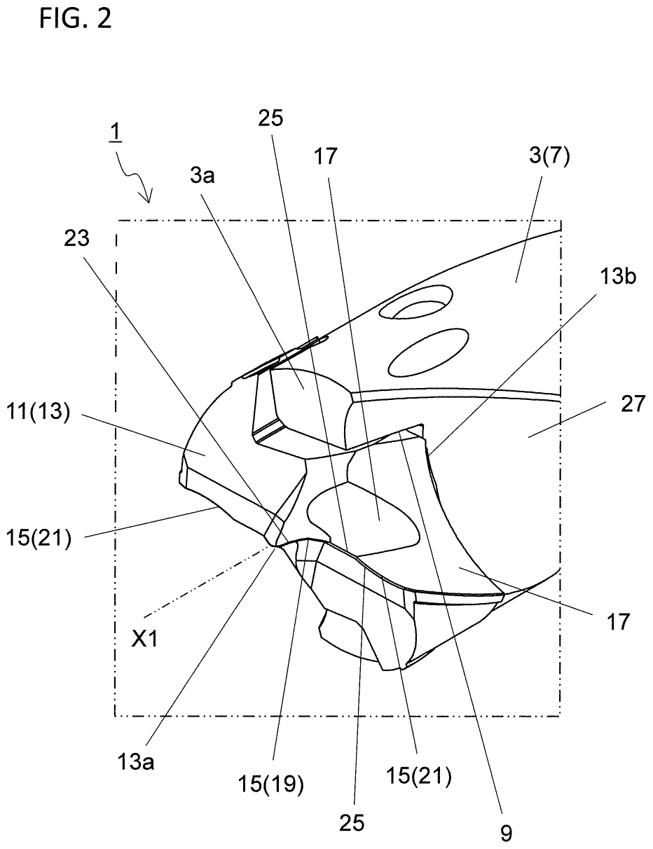

The body 7 of the holder 3 may include a pocket 9 located close to the front end 3a. The body 7 may include only one pocket 9, or alternatively a plurality of pockets 9. The holder 3 may include the single pocket 9 in one embodiment illustrated in FIG. 2. The pocket 9 may open into each of a side of the front end 3a and a side of an outer peripheral surface in the holder 3 as in the embodiment illustrated in FIG. 1.

The pocket 9 may be a part that permits attachment of a cutting insert 11. The cutting insert 11 may be referred to simply as the insert 11. The insert 11 may be located in the pocket 9. In other words, the rotary tool 1 may include the insert 11 located on a side of the front end 3a. The insert 11 may be in direct contact with the pocket 9, or alternatively a sheet may be held between the insert 11 and the pocket 9. The insert 11 may be attachable to and detachable from the holder 3 in the present embodiment.

In cases where the rotary tool 1 is constituted by the holder 3 and the insert 11 as in the embodiment illustrated in FIGS. 1 and 2, the rotary tool 1 may generally be called an indexable tool. In cases where the rotary tool 1 is constituted by one member as described later, the rotary tool 1 may generally be called a solid tool.

The insert 11 may include a base 13, a cutting edge 15 and a first flute 17. The base 13 may include a rotation axis X1 and may be extended from a first end 13a to a second end 13b. A lower left end may be a first end 13a, and an upper right end may be a second end 13b in the embodiment illustrated in FIG. 1.

Both the side of the front end 3a in the holder 3 and the side of the first end 13a in the insert 11 may denote a lower left in FIG. 1. Both the side of the rear end 3b in the holder 3 and the side of the second end 13b in the insert 11 may denote an upper right in FIG. 1. The cutting edge 15 may be located close to the first end 13a of the base 13. The first flute 17 may be extended from the cutting edge 15 toward the second end 13b of the base 13.

The cutting edge 15 may be usable for cutting out a workpiece in a cutting process. The cutting edge 15 may be located in the vicinity of the first end 13a, and specifically may be located so as to include the first end 13a. The cutting edge 15 may include a first cutting edge 19 and a second cutting edge 21 as in the embodiment illustrated in FIG. 2. The first cutting edge 19 may intersect with the rotation axis X1 in a front view.

A first rake angle θ1 on the first cutting edge 19 may have a negative value. The first cutting edge 19 may generally also be called a chisel edge. The second cutting edge 21 may be located closer to the outer periphery than the first cutting edge 19. A second rake angle θ2 on the second cutting edge 21 may have a positive value. As used herein, the term “the front view” may denote a situation where the insert 11 is viewed from the font end 3a.

In the above embodiment, the first rake angle θ1 of the first cutting edge 19 may have the negative value, and the second rake angle θ2 of the second cutting edge 21 may have the positive value. A boundary between the first cutting edge 19 and the second cutting edge 21 may be evaluated by a portion where the rake angle changes from the negative value to the positive value as going toward the outer periphery.

The cutting edge 15 may include only one or a plurality of second cutting edges 21. The cutting edge 15 may include two second cutting edges 21 as in the embodiment illustrated in FIG. 2. These two second cutting edges 21 may individually connect to the first cutting edge 19 as in the embodiment illustrated in FIG. 2.

As used herein, “the rake angle” can be evaluated in a cross section which is orthogonal to a part of the cutting edge that becomes an object in the front view, and which is parallel to the rotation axis X1. For example, the rake angle can be evaluated by an angle formed by an imaginary straight line parallel to the rotation axis X1 and a part of the first flute 17 which is located along the cutting edge 15 in the above cross section. If the part of the first flute 17 which is located along the cutting edge 15 is located ahead of the cutting edge 15 in the rotation direction, the rake angle may have a negative value. If the part of the first flute 17 which is located along the cutting edge 15 is located behind the cutting edge 15 in the rotation direction, the rake angle may have a positive value.

The first rake angle θ1 and the second rake angle θ2 are not limited to a specific value. A minimum value of the first rake angle θ1 may be settable to, for example, from −30° to −50°. A maximum value of the second rake angle θ2 may be settable to, for example, from 1° to 40°. If the first rake angle θ1 has a negative value, the minimum value of the first rake angle θ1 may be, in other words, a maximum value of an absolute value of the first rake angle θ1.

Although the first rake angle θ1 and the second rake angle θ2 are evaluated in the cross section parallel to the rotation axis X1 in the present embodiment, the base 13 does not necessarily have to be cut off. A surface configuration of the base 13 may be scanned, and a cross section that is imaginarily parallel to the rotation axis X1 may be evaluated from data obtained by scanning the surface configuration.

A shape and a position of the cutting edge 15 are not limited to a specific configuration. For example, the cutting edge 15 may have a shape that is 180° rotational symmetry on the basis of the rotation axis X1 in the front view of the insert 11. The first cutting edge 19 and the second cutting edge 21 may have a straight line shape or a curvilinear shape in the front view.

The first flute 17 may be usable for discharging chips generated by the cutting edge 15 to the outside. Because the cutting edge 15 includes the two second cutting edges 21 in the embodiment illustrated in FIG. 2, the insert 11 may include two first flutes 17. The first flutes 17 may be extended parallel to the rotation axis X1, or alternatively may be twisted around the rotation axis X1. In other words, the first flutes 17 may be extended spirally around the rotation axis X1. For example, the first flutes 17 may have a concave curvilinear shape in a cross section orthogonal to the rotation axis X1 from the viewpoint of a smooth discharge of the chips to the outside.

The cutting edge 15 may be located on a ridgeline where two surfaces intersect with each other. From the viewpoint of cutting edge durability, the cutting edge 15 may not strictly be located on the ridgeline. That is, the cutting edge 15 may be subjected to honing. Specifically, the first cutting edge 19 may be formed by round honing, and the second cutting edge 21 may be formed by chamfer honing.

As used herein, the term “round honing” may denote that a convex curved surface 23 connecting to two surfaces is disposed on a ridgeline where these two surfaces intersect with each other. The term “chamfer honing” may denote that a flat surface 25 connecting to two surfaces is disposed on a ridgeline where these two surfaces intersect with each other.

In the case of applying the round honing to the first cutting edge 19 located so as to intersect with the rotation axis X1 in the front view, the cutting edge 15 may have enhanced strength and enhanced biting properties. This may be because the first cutting edge 19 that bites into a workpiece is less likely to be brought into surface contact with the workpiece if the convex curved surface 23 instead of the flat surface 25 is disposed on the first cutting edge 19.

In the case of applying the chamfer honing to the second cutting edge 21 located closer to the outer periphery than the first cutting edge 19, the cutting edge 15 may have particularly enhanced strength. This may be because, if the flat surface 25 instead of the convex curved surface 23 is disposed on the second cutting edge 21 that cuts out a workpiece, the second cutting edge 21 has further enhanced durability than being formed by the round honing, and chipping is less likely to occur.

A honing width of the first cutting edge 19 and that of the second cutting edge 21 are not limited to a specific value in the front view. A honing width W11 in the first cutting edge 19 in a direction orthogonal to the first cutting edge 19 may be smaller than a honing width W12 on the second cutting edge 21 in a direction orthogonal to the second cutting edge 21. Biting properties of the first cutting edge 19 may be improved if the honing width W11 is relatively small. Durability of the second cutting edge 21 may be improved if the honing width W12 is relatively large.

The holder 3 may include a second flute 27 connecting to the first flute 17. If the holder 3 includes the second flute 27, chips that are generated by the cutting edge 15 and pass through the first flute 17 can be directed to the second flute 27. The first flute 17 may be extended parallel to the rotation axis X1, or alternatively may be extended spirally around the rotation axis X1. A helix angle of the first flute 17 may be identical with or different from a helix angle of the second flute 27.

The second flute 27 may be formed on the body 7 but may not be formed on the shank 5 in the holder 3. If the second flute 27 is not formed on the shank 5, the holder 3 can be held stably in a machine tool.

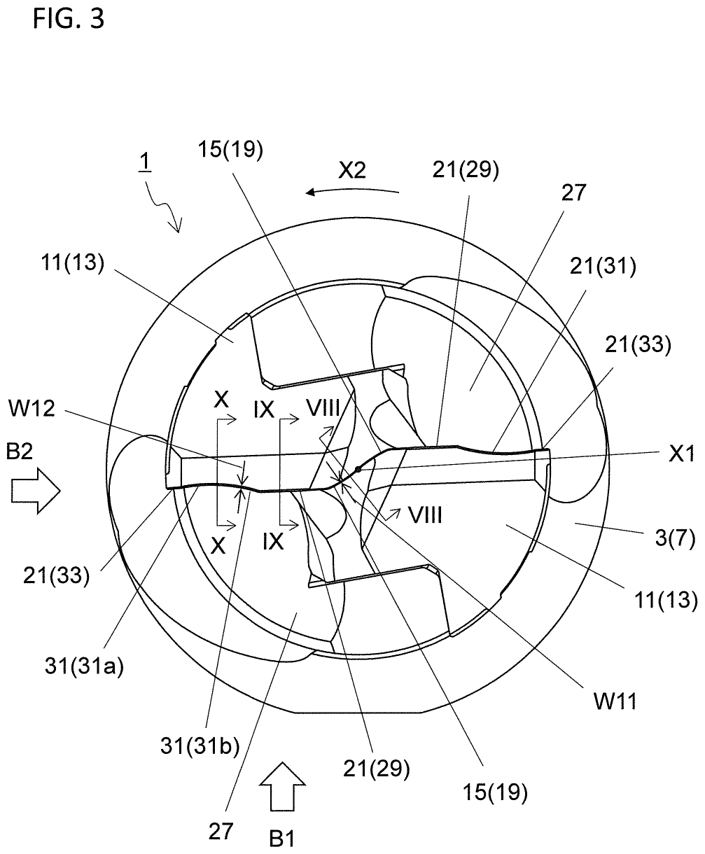

The second cutting edge 21 may include a first portion 29, a second portion 31 and a third portion 33 as in one embodiment illustrated in FIG. 3. The first portion 29 may have a straight line shape as in the embodiment illustrated in FIG. 3. The second portion 31 may be located closer to the outer periphery than the first portion 29 and may have a concave curvilinear shape in the front view as in the embodiment illustrated in FIG. 3. The third portion 33 may be located closer to the outer periphery than the first portion 29, and may have a straight line shape as in the embodiment illustrated in FIG. 3.

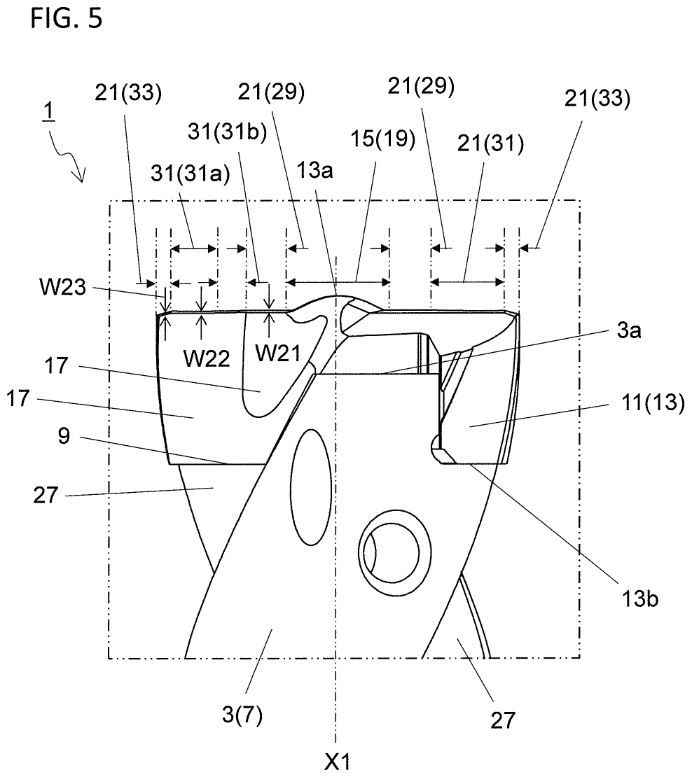

In cases where the second cutting edge 21 includes the first portion 29 and the second portion 31, a honing width W22 on the second portion 31 in the direction along the rotation axis X1 may be smaller than a honing width W21 on the first portion 29 in the direction along the rotation axis X1 as illustrated in FIG. 5. In other words, the honing width W21 on the first portion 29 in the direction along the rotation axis X1 may be larger than the honing width W22 on the second portion 31 in the direction along the rotation axis X1. FIG. 5 may be a diagram of the second cutting edge 21 in a front view in the rotation direction of the rotation axis X1.

Because the first portion 29 has a relatively low cutting speed, the first portion 29 may be more susceptible to chipping than the second portion 31 having the cave curved surface shape. If the honing width W21 on the first portion 29 susceptible to the chipping is relatively large, the durability of the second cutting edge 21 can be improved. If the honing width W22 on the second portion 31 located closer to the outer periphery than the first portion 29 is relatively small, the second portion 31 may be subjected to small cutting resistance. This may make it possible to reduce chatter vibration, thus leading to enhanced machining accuracy.

The second portion 31 may have higher cutting speed as going toward the outer periphery. Accordingly, the second portion 31 may tend to be subjected to larger cutting resistance as going toward the outer periphery. From the viewpoint of improving the durability of the second portion 31 while minimizing cutting resistance in the second portion 31, the second portion 31 may include a first region 31a where the honing width W22 increases as going toward the outer periphery.

The second portion 31 may further include a second region 31b located between the first portion 29 and the first region 31a. The honing width W22 of the second region 31b may decrease as going toward the outer periphery. If the second portion 31 includes the second region 31b, the honing width may less be likely to change sharply at a boundary between the first portion 29 and the second portion 31. This may lead to enhanced durability of the second cutting edge 21 at the boundary between the first portion 29 and the second portion 31.

In cases where the second portion 31 includes the first region 31a, a honing angle ϕ1 on the first region 31a may be kept constant or alternatively may decrease as going toward the outer periphery. If the honing angle ϕ1 decreases as going toward the outer periphery, a part of the first region 31a which is located closer to the outer periphery may have higher durability. Consequently, the durability of the second portion 31 can be improved while minimizing the cutting resistance in the second portion 31.

In cases where the second portion 31 includes the second region 31b, a honing angle ϕ2 on the second region 31b may be kept constant or alternatively may increase as going toward the outer periphery. In other words, the honing angle ϕ2 on the second region 31b may decrease as going toward the rotation axis X1. If so, the honing angle may be less likely to change sharply at the boundary between the first portion 29 and the second portion 31. This may lead to the enhanced durability of the second cutting edge 21 at the boundary between the first portion 29 and the second portion 31.

The honing angle can be evaluated in a cross section which is orthogonal to a part of the cutting edge 15 that becomes an object in the front view, and which is parallel to the rotation axis X1. For example, the honing angle can be evaluated by an acute angle formed by an imaginary straight line parallel to the rotation axis X1 and the flat surface 25 in the above cross section.

In cases where the second cutting edge 21 includes the first portion 29, the second portion 31 and the third portion 33, the honing width W23 on the third portion 33 in the direction along the rotation axis X1 may be smaller than the honing width W21 on the first portion 29 in the direction along the rotation axis X1 in a front view of the second cutting edge 21 in the rotation direction of the rotation axis X1. If the honing width W23 on the third portion 33 located closer to the outer periphery than the first portion 29 is relatively small, the third portion 33 may be subjected to low cutting resistance. This may contribute to reducing chatter vibration, thus leading to enhanced machining accuracy.

Alternatively, the honing width W23 on the third portion 33 may be smaller than the honing width W22 on the second portion 31. If the honing width W23 on the third portion 33 located closer to the outer periphery than the second portion 31 is relatively small, the third portion 33 may be subjected to low cutting resistance. This may contribute to reducing chatter vibration, thus leading to the enhanced machining accuracy.

If the third portion 33 is located closest to the outer periphery in the second cutting edge 21, a wall surface of a machined hole may be formed by the third portion 33. If the honing width W23 on the third portion 33 is relatively small and the third portion 33 is subjected to small cutting resistance, the wall surface of the machined hole may have high surface accuracy.

As described earlier, the second rake angle θ2 on the second cutting edge 21 may have the positive value in the insert 11 of the present embodiment. The second rake angle θ2 on the second cutting edge 21 may be kept constant or may be changed. For example, if the second cutting edge 21 includes the first portion 29 and the second portion 31, the second rake angle θ22 on the second portion 31 may be larger than the second rake angle θ21 on the first portion 29.

The second portion 31 may be located closer to the outer periphery than the first portion 29. Consequently, a larger amount of chips may tend to occur at the second portion 31 than at the first portion 29. If the second rake angle θ22 on the second portion 31 is larger than the second rake angle θ21 on the first portion 29, chips generated at the second portion 31 may tend to pass through the first flute 17. Chip clogging may be less likely to occur because the chips are easy to pass through a region where the larger amount of chips tend to occur.

For example, cemented carbide or cermet may be usable as a material of the insert 11 that constitutes the rotary tool 1. Examples of composition of the cemented carbide may include WC—Co, WC—TiC—Co and WC—TiC—TaC—Co, in which WC, TiC and TaC are hard particles, and Co is a binding phase.

The cermet may be a sintered composite material obtainable by compositing metal into a ceramic component. Examples of the cermet may include titanium compounds composed mainly of titanium carbide (TiC) or titanium nitride (TiN).

A surface of the insert 11 may be coated with a coating film by using chemical vapor deposition (CVD) method or physical vapor deposition (PVD) method. Examples of composition of the coating film may include titanium carbide (TiC), titanium nitride (TiN), titanium carbonitride (TiCN) and alumina (Al₂O₃).

For example, steel, cast iron or aluminum alloy may be usable as a material of the holder 3 constituting the rotary tool 1. Steel may be preferable in terms of high toughness.

In cases where the holder 3 and the insert 11 are formed by a single member, the same material as the insert 11 may be usable as a material of the member.

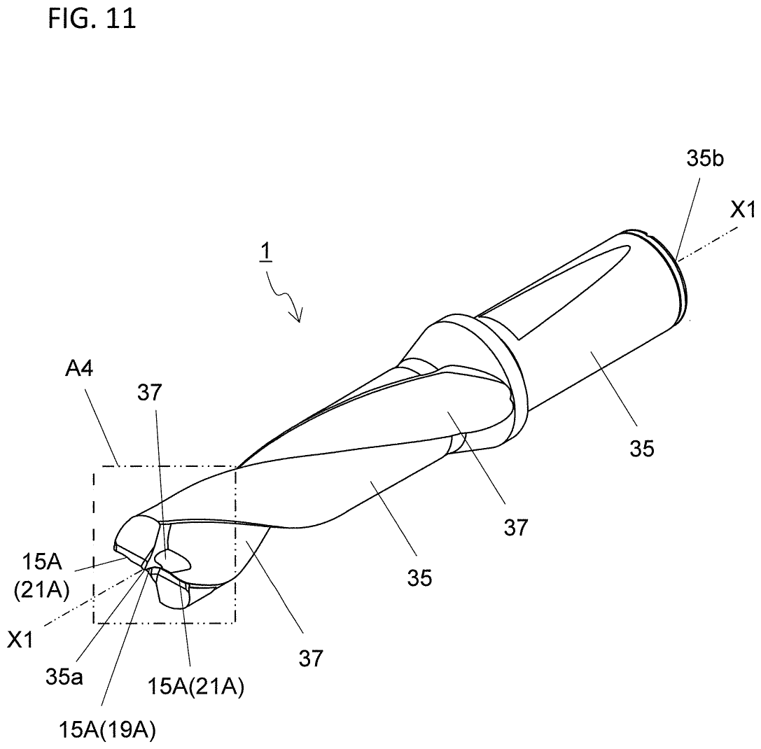

The rotary tool 1 of the above embodiment may be the indexable tool including the holder 3 and the insert 11. Alternatively, a rotary tool 1A may have a configuration that is generally called a solid tool. FIG. 11 may illustrate one embodiment in which the rotary tool 1A is the solid tool. Similarly to the rotary tool 1 illustrated in FIG. 1, the rotary tool 1A illustrated in FIG. 11 may be a drill.

The rotary tool 1A may include a base body 35, a cutting edge 15A and a flute 37. The base body 35 may have a bar shape rotatable around the rotation axis X1, and may be extended from a third end 35a to a fourth end 35b. The base body 35 in the present embodiment may correspond to the holder 3 and the insert 11 in the embodiment illustrated in FIG. 1.

A part of the base body 35 which is located close to the third end 35a may denote a lower left in FIG. 11. A part of the base body 35 which is located close to the fourth end 35b may denote an upper right in FIG. 11. The third end 35a in the embodiment illustrated in FIG. 11 may correspond to the first end 13a in the embodiment illustrated in FIG. 1. The fourth end 35b in the embodiment illustrated in FIG. 11 may correspond to the rear end 3b in the embodiment illustrated in FIG. 1.

The cutting edge 15A may be located on a side of the third end 35a of the base body 35. The cutting edge 15A may be located in a region including the third end 35a. The flute 37 may be extended spirally from the cutting edge 15A toward the fourth end 35b of the base body 35. In other words, the flute 37 may be twisted around the rotation axis X1. The flute 37 in the present embodiment may correspond to the first flute 17 and the second flute 27 in the embodiment illustrated in FIG. 1.

Similarly to the cutting edge 15 in the embodiment illustrated in FIG. 1, the cutting edge 15A in the present embodiment may include a first cutting edge 19A and a second cutting edge 21A. Further, the first cutting edge 19A may be formed by round honing, and the second cutting edge 21A may be formed by chamfer honing in the present embodiment as in the embodiment illustrated in FIG. 1. Accordingly, a convex curved surface 23A may be disposed on the first cutting edge 19A, and a flat surface 25A may be disposed on the second cutting edge 21A. Thus, the cutting edge 15 may also have high strength and enhanced biting properties in the rotary tool 1A in the embodiment illustrated in FIG. 11.

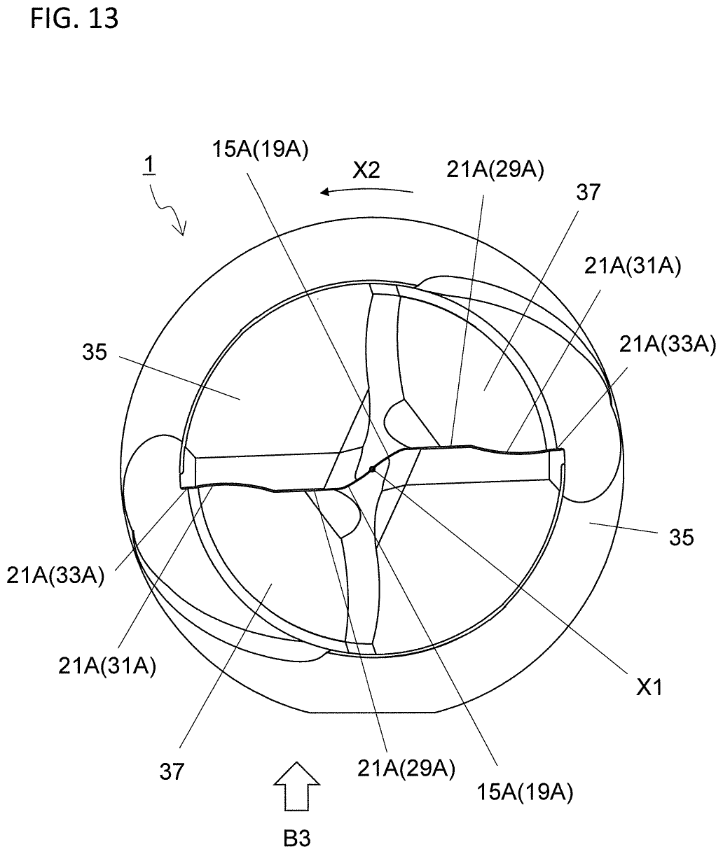

Although the rotary tools 1 and 1A in the embodiments have been illustrated above, the present disclosure is not limited thereto, it may, of course, be possible to make an arbitrary one as long as not departing from the scope of the present disclosure. Similarly to the rotary tool 1 in the embodiment illustrated in FIG. 3, for example, the second cutting edge 21 may include a first portion 29A, a second portion 31A and a third portion 33A in the rotary tool 1A in one embodiment illustrated in FIG. 13.

<Method for Manufacturing Machined Product>

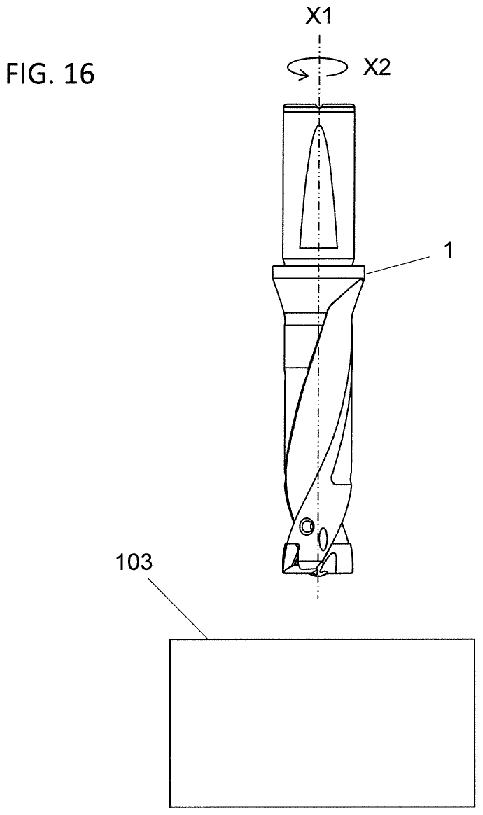

A method for manufacturing a machined product 101 in one non-limiting aspect of the present disclosure may be described in detail below by exemplifying the case of using the rotary tool 1 in the above embodiment. The machined product 101 may be manufacturable by carrying out a cutting process of a workpiece 103. The method may be described below with reference to FIGS. 16 to 18.

The method for manufacturing the machined product 101 may include the following steps (1) to (4).

(1) Putting the rotary tool 1 above the prepared workpiece 103 (refer to FIG. 16).

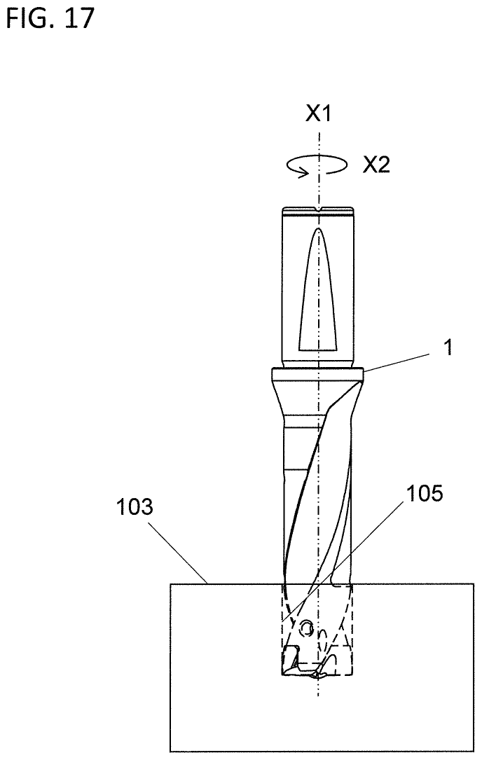

(2) Rotating the rotary tool 1 around the rotary axis X1 in a direction of an arrow X2, and bringing the rotary tool 1 near the workpiece 103 in a Y1 direction (refer to FIGS. 16 and 17).

The above step can be carried out by, for example, fixing the workpiece 103 to a table of a machine tool with the rotary tool 1 attached thereto, and by bringing the rotary tool 1 being rotated near the workpiece 103. In the above step, the workpiece 103 may be brought relatively near the rotary tool 1. For example, the workpiece 103 may be brought near the rotary tool 1.

(3) Forming a machined hole (through hole) 105 in the workpiece 103 by bringing the rotary tool 1 further near the workpiece 103 so that the cutting edge of the rotary tool 1 being rotated comes into contact with a desired position on a surface of the workpiece 103 (refer to FIG. 17).

In the above step, the cutting process may be carried out so that at least a part of the body in the holder is located in a machined hole. Alternatively, setting may be made so that the shank in the holder is located outside the machined hole 105. From the viewpoint of obtaining a good finished surface, setting may be made so that a part of the body which is close to the rear end is located outside the machined hole 105. The part may be servable as a margin region for discharging chips, thereby offering excellent chip discharge performance through the region.

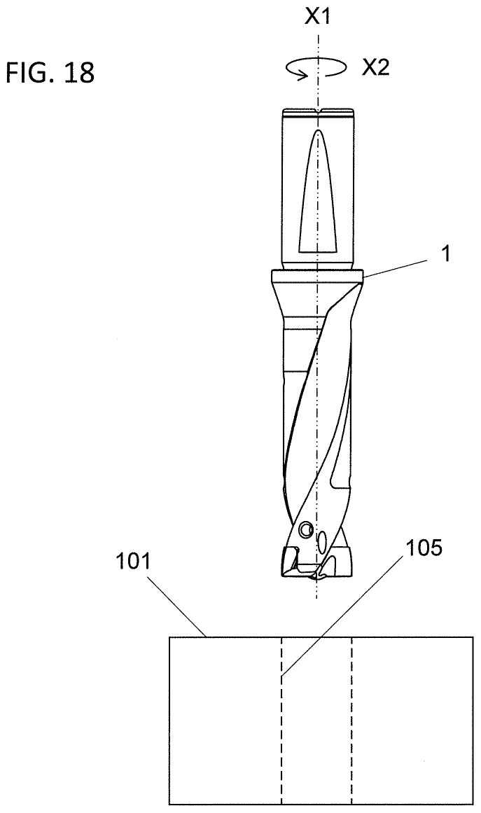

(4) Moving the rotary tool 1 away from the workpiece 103 in Y2 direction (refer to FIG. 18).

Also in the above step, the workpiece 103 and the rotary tool 1 may be relatively moved away from each other as in the step (2). For example, the workpiece 103 may be moved away from the rotary tool 1.

Excellent machinability can be offered by undergoing the foregoing steps.

In cases where the above cutting process of the workpiece 103 is carried out a plurality of times and, for example, a plurality of machined holes 105 may be formed in the single workpiece 103, the step of bringing the cutting edge of the rotary tool 1 into contact with different portions of the workpiece 103 may be repeated while keeping the rotary tool 1 rotated.

### DESCRIPTION OF THE REFERENCE NUMERAL

1 rotary tool
3 holder
3a front end
3b rear end
5 shank
7 body
9 pocket
11 cutting insert (insert)
13 base
13a first end
13b second end
15, 15A cutting edge
17 first flute
19, 19A first cutting edge
21, 21A second cutting edge
23, 23A convex curved surface
25, 25A flat surface
27 second flute
29, 29A first portion
31, 31A second portion
31a first region
31b second region
33, 33A third portion
35 base body
37 flute
101 machined product
103 workpiece
X1 rotation axis
X2 rotation direction
D outer diameter
L length
ϕ1, ϕ2 honing angle
θ1 first rake angle
θ2 second rake angle
W11, W12, W21, W22, W23 honing width

1. A cutting insert, comprising:
a base including a rotation axis and being extended from a first end to a second end;
a cutting edge located on a side of the first end of the base; and
a flute extended from the cutting edge toward the second end of the base,
wherein
the cutting edge comprises
a first cutting edge that intersects with the rotation axis in a front view, and
a second cutting edge which is located closer to an outer periphery than the first cutting edge and whose rake angle has a positive value, and
the first cutting edge is formed by round honing, and the second cutting edge is formed by chamfer honing.

2. The cutting insert according to claim 1, wherein a honing width on the first cutting edge in a direction orthogonal to the first cutting edge is smaller than a honing width on the second cutting edge in a direction orthogonal to the second cutting edge in the front view.

3. The cutting insert according to claim 1, wherein
the second cutting edge comprises
a first portion having a straight line shape, and
a second portion which is located closer to the outer periphery than the first portion and has a concave curvilinear shape, and
a honing width on the second portion in a direction along the rotation axis is smaller than a honing width on the first portion in the direction along the rotation axis.

4. The cutting insert according to claim 3, wherein the second portion comprises a first region whose honing width in the direction along the rotation axis increases toward the outer periphery.

5. The cutting insert according to claim 4, wherein a honing angle on the first region decreases toward the outer periphery.

6. The cutting insert according to claim 4, wherein the second portion further comprises a second region which is located between the first portion and the first region and whose honing width decreases toward the outer periphery.

7. The cutting insert according to claim 6, wherein a honing angle on the second region increases toward the outer periphery.

8. The cutting insert according to claim 3, wherein
the second cutting edge further comprises a third portion which is located closer to the outer periphery than the second portion and has a straight line shape, and
a honing width on the third portion in the direction along the rotation axis is smaller than the honing width on the first portion in the direction along the rotation axis.

9. The cutting insert according to claim 8, wherein the honing width on the third portion in the direction along the rotation axis is smaller than the honing width on the second portion in the direction along the rotation axis.

10. The cutting insert according to claim 3, wherein a rake angle on the second portion is larger than a rake angle on the first portion.

11. A rotary tool, comprising:
a holder comprising a pocket located close to a front end; and
the cutting insert according to claim 1, the cutting insert being located in the pocket.

12. A rotary tool, comprising:
a base body including a rotation axis and having a bar shape being extended from a first end to a second end;
a cutting edge located on a side of the first end of the base body; and
a flute being extended spirally from the cutting edge toward the second end of the base body,
wherein
the cutting edge comprises
a first cutting edge that intersects with the rotation axis in a front view, and
a second cutting edge which is located closer to an outer periphery than the first cutting edge and whose rake angle has a positive value, and
the first cutting edge is formed by round honing, and the second cutting edge is formed by chamfer honing.

13. A method for manufacturing a machined product, comprising:
rotating a workpiece;
bringing the rotary tool according to claim 11 into contact with the workpiece being rotated; and
moving the rotary tool away from the workpiece.
